(19) United States
(12) Patent Application Publication
(10) Pub. No.: US 2004/0176147 A1
(43) Pub. Date: Sep. 9, 2004

(54) Power conservation in a mobile communication device utilizing variable reacquisition time in a discontinuous reception regime

(76) Inventor: Wilberth Escalante, La Jolla, CA (US)

Correspondence Address: Milan Patel, c/o Nokia Mobile Phones (Patent Dept.), Mail Stop 1-4-755, 6000 Connection Drive, Irving, TX, 75039, US

(21) Appl. No.: 10/383,889

(22) Filed: Mar. 6, 2003

(51) Int. Cl. H04B 1/38; H04B 1/00

(52) U.S. Cl. 455/574; 455/69

(57) ABSTRACT

Architecture for conserving power in a mobile communications device operating in discontinuous reception mode. The reacquisition time associated with a received signal is determined based on the active window size of the signal, resolution of the coarse sleep clock of the mobile communications device, frequency of the coarse sleep clock, and multipath time differential. The reacquisition times for a plurality of mobile device products are determined and stored in a look-up table in the mobile device. Thereafter, once the particular active set window size is determined form the received signal, the corresponding reacquisition time is retrieved from the table and used to periodically activate the mobile communications device so that the received signal can be processed to determine if a paging slot message is available.

### TECHNICAL FIELD

This invention is related to mobile communication devices, and more particularly, to such devices using CDMA in a discontinuous reception mode.

### BACKGROUND OF THE INVENTION

The lucrative mobile communications market has many manufacturers racing to meet consumer demands for more feature rich devices and increased connection time. These devices can include not only simple monochrome displays, but color displays, variety of different types of alerts, enhanced processing power and memory capacity, etc., all of which place increased demand on the power source. As these mobile devices get smaller and smaller, so do the physical requirements for batteries, a field in which a larger size typically indicates greater capacity to sustain device operation longer. Thus manufacturers are striving to meet these consumer demands in this highly competitive market by seeking more clever ways to reduce power consumption in such mobile devices so that the consumer can utilize the device for increasingly longer periods of time.

In communications regimes where a multiplicity of mobile communications devices (e.g., a radiotelephone) shares a single base station, a number of techniques can be employed in order to avoid interference between respective communication channels. One such technique is code division multiple access (hereinafter referred to as CDMA). In CDMA, a specific code assigned to each channel (e.g., PN (pseudo-random noise sequence) code) is used for spreading modulated waves of one carrier frequency to another band wider than the original frequency band (hereinafter referred to as spread spectrum).

On the transmission side, different orthogonal codes are uniquely assigned to different channels within one base station. The modulated wave to be transmitted via a relevant channel is multiplied by the respective PN and orthogonal code in accordance with spread spectrum architecture processing. The modulated wave thus processed is then multiplexed and transmitted. On the reception side, the signal received from the transmission side is processed through inverse spread spectrum by synchronous multiplication of the same PN code as that assigned to the subject demodulation channel, so that only the modulated wave transmitted via the desired channel can be demodulated. The received spread spectrum signal is synchronized with the supplied PN code via a subject demodulation channel, whereby only the desired channel is identified—typically, other received waves are ignored. Thus in accordance with CDMA techniques, communication can be established per call if the mutually identical PN code is present on both the transmission and reception sides.

Each base station (in the context of a transmission role) repeatedly sends pilot signals in the form of PN codes having mutually different timings for attaining synchronism with the mobile device (or radiotelephone), maintaining synchronization, and reproducing clock pulses. Thus the radiotelephone may receive a number of pilot signals from a respective number of base stations, and preferably searches to select the strongest signal. In each radiotelephone (in the context of a reception role), the pilot signals received from a plurality of base stations are detected, and the timings of detection are allocated to the respective individual demodulators. Each radiotelephone receiving the pilot signal(s) detects the timing of the pilot signal supplied from the base station, synchronizes the PN code that is generated in its demodulator, and executes inverse spread spectrum through multiplication by the generated PN code at the allocated timing, thereby properly demodulating only the spread spectrum signal transmitted from the desired base station.

Although the base stations transmit PN codes of mutually different timings, the PN codes themselves are in the same code pattern. That is, the timing difference between the different pilot signals of the individual base stations corresponds directly to the difference between the PN codes of the base stations.

The use of a pilot signal enables the radiotelephone to acquire a local base station communication system in a timely manner. The radiotelephone obtains synchronization information, including the PN code phase offset, and relative signal power information from the received pilot signal. Once a pilot channel has been acquired, the radiotelephone acquires a synchronization channel that is associated with the pilot channel, to receive fine-tuning of its timing instructions and thereby permit the radiotelephone to temporally synchronize its internal circuitry with the radiotelephone system time. It can be appreciated that in order to enable communication between the base station and the radiotelephone it is important that the internal time of the radiotelephone be synchronized with the base station system time, particularly in CDMA systems, to enable the radiotelephone to detect where in the PN code sequence the base station information is located. Accordingly, when the radiotelephone is in contact with the base station, the base station transmits system time to the radiotelephone to facilitate synchronization by realigning the device clocks before despreading occurs.

After synchronization, the radiotelephone monitors yet a third channel, commonly referred to as the “paging channel,” for incoming calls. To increase system capacity, some radiotelephone systems use so-called “slotted paging”, which relies on what might be thought of as temporal multiplexing of the paging channel. In other words, a radiotelephone in a slotted paging environment is assigned periodic windows of time (referred to as “slots”) during which the radiotelephone may be paged, with the periods between the windows being reserved for paging other radiotelephones via the same paging channel.

To advantageously conserve battery power, the radiotelephone ordinarily is partially “powered down” between slots, in that most, but not all, of the electrical components of the radiotelephone are de-energized. When partially powered down, the radiotelephone device is referred to as being “asleep,” at which time the device does not demodulate the pilot signal, perform synchronization, or process paging channel broadcasts by the transmitter.

However, in an attempt to maintain synchronization, an internal clock of the radiotelephone keeps time. Some time prior to the assigned slot, the internal clock indicates that the assigned “sleep” period of the radiotelephone device has terminated, and accordingly, the device “powers up” (or awakens) to monitor its paging channel. Once awakened, the mobile device also seeks to reacquire and monitor the paging channel that is associated with the assigned pilot channel.

As can happen between two unsynchronized timing devices (here the base station and the radiotelephone), small timekeeping discrepancies develop between the internal clock of the radiotelephone and the system time during sleep mode. These discrepancies need to be reconciled when the radiotelephone awakens. Consequently, when the mobile radiotelephone awakens, reacquisition of the pilot channel can be delayed, requiring increased power consumption, since the internal time of the radiotelephone indicates location of pilot channel in the PN code sequence that is different from the actual location in the received signal. Moreover, any relative motion of the radiotelephone with respect to the base station, e.g., moving closer or farther away while driving, further compounds this time discrepancy problem while the radiotelephone is asleep.

After disconnection of the call, it is desired that the radiotelephone be reset immediately to a state ready for receiving mobile communication service again. After the radiotelephone disconnects the call, the phone will reacquire the system, the rules on how to reacquire the system varying between cellular carriers. Note also that the phone may not end up in the same paging channel as before the call. The active window size of a base station is unique and is used to search for multipaths centered around the PN offset. This window size is always used by the radiotelephone during paging or during traffic. The window size used during system reacquisition in DRX mode is wider, since has to consider the timing errors.

Obviously, this reacquisition search window should be sufficiently small to avoid prolonged searching, and sufficiently large to account for typical internal clock errors and for external factors such as changes in the radio frequency propagation channel. In complex systems, a searcher (or search processor) is required to search a window of many hypotheses and upon finding a candidate synchronization sequence, repeat the search over the window a predetermined number of times to verify the synchronization. This process requires an unacceptably long acquisition time, however, causing increased power demands on the radiotelephone power source.

As recognized herein, the relative inflexibility of the search window size can result in inefficient and unsuccessful searches, thereby requiring the mobile radiotelephone to completely reinitialize, a procedure that is a relatively lengthy and thus undesirable, further increasing power consumption of the mobile device.

Slotted paging mode is a form of discontinuous reception (DRX) used in CDMA systems to reduce power consumption in battery-operated radiotelephones. Under the discontinuous reception regime, the radiotelephone monitors the paging channel or the quick paging channel (paging channel indicator bit) for a period of awake time and turns off a portion of the radiotelephone circuitry to reduce power consumption during the sleep state. However, the radiotelephone must wake up and monitor the paging channel once per DRX cycle to reduce the possibility of missing a page, which impacts the battery lifetime.

In order to minimize the time required by the radiotelephone to demodulate the paging channel, the base station transmits an additional channel denoted as the quick paging channel. The quick paging channel includes a paging indicator bit, that when set, indicates an incoming paging message in the paging channel. Once the quick paging bit is detected, the radiotelephone then reads the next slot (or frame) of the slotted paging channel.

However, before the paging bit and slot information can be demodulated, the radiotelephone has to power up and settle (or stabilize) the necessary receiver circuitry, reacquire the pilot signal in order to re-synchronize its system timing with the base station (i.e., re-synchronize with the long PN sequence and with the short PN sequence), and find the multipath signals received from all base stations in the active set using the searcher in order to assign at least one finger of the rake receiver, and start demodulating the desired channel. This time is known in the art as reacquisition time. The time it takes to re-synchronize depends on the error of the sleep clock (coarse resolution,) on the window size of the active set (i.e., pilot channel) and on the speed at which the search logic operates.

As previously mentioned, the reacquisition time depends on many factors such as the settling time for analog circuitry and the processor speed. In order to minimize power consumption, the reacquisition time should be minimized. Conventionally, most of these factors are fixed for a specific implementation, and as indicated hereinabove, the fixed setup time in the prior art is tailored according to worst case scenarios, or adaptive methods are employed that speculate on past conditions. Therefore, there is a need for a method and apparatus for minimizing the reacquisition time that avoids the limitations of prior art.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention disclosed and claimed herein, in one aspect thereof, comprises a novel and improved method and apparatus for reducing power consumption in a mobile communications device, such as a radiotelephone, when operating in discontinuous reception mode of a CDMA system. More particularly, the present invention relates to an architecture and/or methodology for determining the optimal reacquisition window size and reacquisition time associated with a given mobile communications device and acquired signal such that the associated reacquisition time is utilized to periodically activate the mobile device to reacquire, resynchronize, and check the paging channel and/or quick paging channel. The reacquisition time is based in part on size of an active set window of the received signal and, drift, resolution of a coarse sleep clock source, and multipath time differential of the mobile communications device. The reacquisition time utilized for a given mobile communications device is variable, since the reacquisition time is proportional to the variable active set window size as provided by the received signal (the window size is provided by a message transmitted on the paging channel). The present invention is substantially optimal, since it considers that the reacquisition time from product to product and received signal varies, and hence, provides for determining and employing such optimal variable time to accommodate for a particular communications environment in which the mobile communications device is operating.

In another aspect of the present invention, there is provided a mobile communications device operating in accordance with stored reacquisition time information such that when operating in a soft environment, the mobile device acquires a plurality of signals and activates periodically according to a plurality of different reacquisition times to check a corresponding signal for paging message information.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a general system block diagram of the present invention.

FIG. 2 illustrates a flow chart of the general methodology of the present invention.

FIG. 3 illustrates a system block diagram comprising a mobile communications device that incorporates novel aspects of the present invention.

FIG. 4 illustrates a flow chart of the methodology for determining the variable reacquisition time in accordance with the present invention.

FIG. 5 illustrates a flow chart of a methodology for implementation of the variable acquisition time in a mobile communications device in accordance with the present invention.

FIG. 6 illustrates a mobile communications device that operates according to the present invention.

FIG. 7 illustrates a portable telephone incorporating novel aspects of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

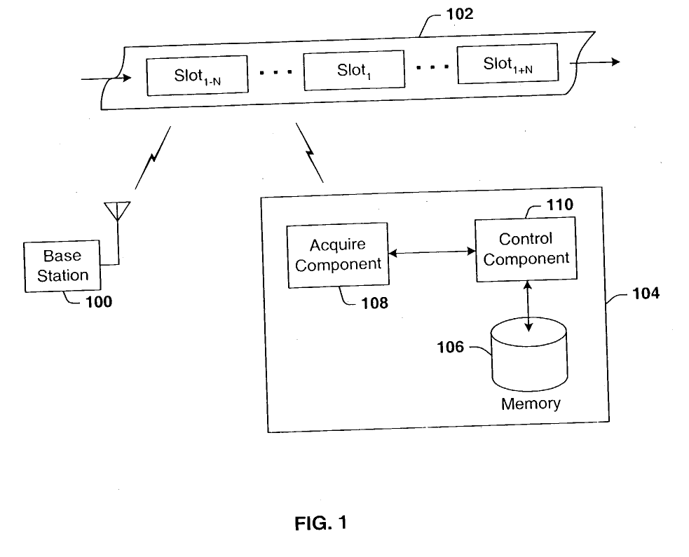

Referring now to FIG. 1, there is illustrated a general system block diagram of the present invention. Operating in a discontinuous reception regime of a Code Division Multiple Access (CDMA) architecture, a base station 100 transmits at least a paging signal 102 (which includes at least a slotted paging signal and in more recent systems, a quick paging indicator channel) that is acquired by a mobile communications device 104 during synchronization. The base station 100 is configured to transmit the paging signal 102 in accordance with active set window data, which data is provided as a time value. The window size value is provided by a message transmitted on the paging channel. Note that the base station could change the active window size every few minutes. The active set window time data can vary from signal to signal. The mobile communications device 104 includes a memory 106 that stores a table of reacquisition time data based upon a number of different active set window data values. The stored reacquisition time values have been generated previously according to a number of factors relating to at least the transmitted signal of the base station 100 and hardware components of the device 104.

The communications device 104 further includes an acquire component 108 that acquires the paging signal 102 such that the communications device 104 can determine active set window time value of the base station 100 provided in the overhead information of the paging signal. Once obtained, a control component 110 of the communications device 104 utilizes the received active set window time value in a look-up operation of the stored table of reacquisition time data to retrieve from the memory 106 the reacquisition time data that corresponds thereto. The control component 110 than uses the reacquisition time data to determine if sufficient time exists before arrival of the next expected paging slot to power down selected circuitry (e.g., analog signal circuits) to conserver power. If so, the control component 110 reduces power consumption by powering down portions of the device 104, and then periodically activates the device 104 according to the reacquisition time data in order to acquire and check the paging signal 102 for paging information directed thereto. If there is not sufficient time, the device 102 will remain powered to process the next paging slot, and then execute periodic activation. Thus depending on the mix of the previously mentioned factors, the reacquisition time data utilized for periodic activation in the communications device 104 can vary facilitating optimum power conservation in the device 104 according to the particular arrangement. This provides a significant improvement over conventional implementations that employ a worst-case reacquisition time for all predictable arrangements, and speculative adaptive times that fail to consider the active set window time.

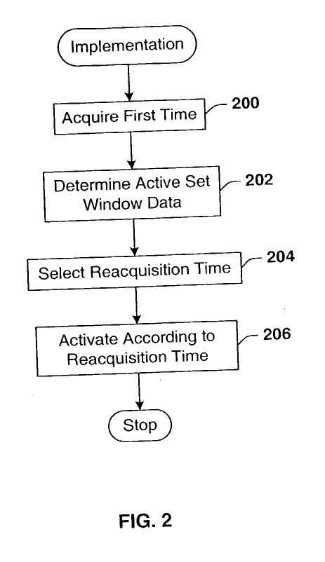

Referring now to FIG. 2, there is illustrated a flow chart of the general methodology of the present invention. While, for purposes of simplicity of explanation, the methodology(s) presented herein and hereinafter are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention. Flow begins at 200 where the mobile communications device 104 acquires and synchronizes to the signal transmitted by the base station 100 for the first time. At 202, the device 104 determines the active set window size information provided in signal packet overhead information. At 204, the corresponding reacquisition time data for the existing base station 100 and device 104 arrangement is selected from the memory 106. Once the device 104 determines in accordance with the reacquisition time data that the time to wait for a next paging slot in the paging signal 102 is sufficiently long, the device 104 powers down a portion of its circuitry to conserve power. At 206, the device 104 then activates periodically in accordance with the reacquisition time data to check the paging signal 102 (and/or the quick paging indicator bit) for the expected paging slot. Flow then reaches a Stop block. It is appreciated that flow can loop back to the input of 206 to indicate continued monitoring according to the reacquisition time.

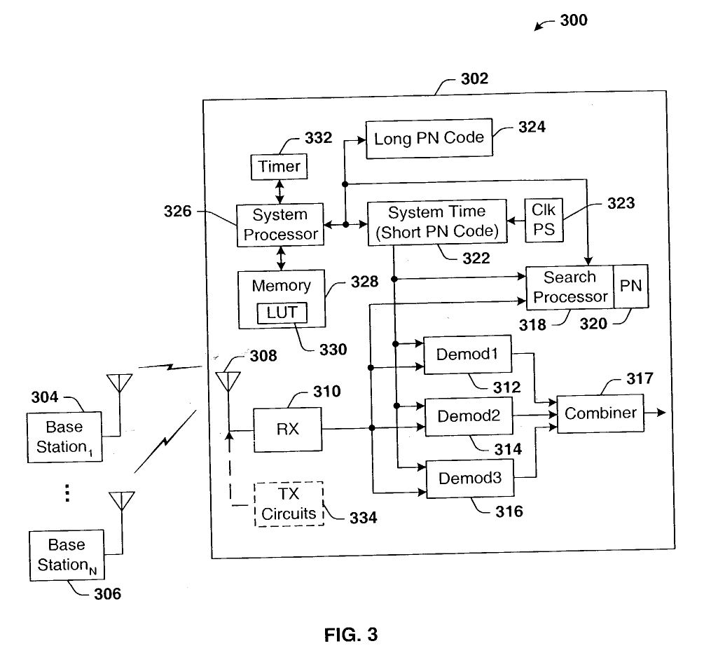

FIGS. 3-6 illustrate flow diagrams relating to methodologies in accordance with the present invention. While, for purposes of simplicity of explanation, the methodologies are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Referring now to FIG. 3, there is illustrated a block diagram of a system 300 comprising a mobile communications device 302 (similar to device 104) that incorporates novel aspects of the present invention. The mobile communications device 302 is capable of wireless communication in discontinuous reception mode in accordance with CDMA principles with at least a first base station 304 (similar to base station 100) of a plurality of base stations 1 . . . N, the Nth base station denoted by 306. The first base station 304 transmits paging channel signals carrying paging channel information that are received by the communications device 302. The communications device 302 includes an antenna 308 for coupling to a receiver 310 transmitted CDMA signals from at least one of the plurality of the N base stations, and more typically, a plurality of the N base stations. The receiver 310 comprises an analog signal-processing component for high-frequency amplification of the received signal, filtering, down-conversion, detection (e.g., quadrature detection), and output baseband processing of the quadrature signals.

The output of the receiver 310 is digitized by an analog-to-digital converter (not shown, but that can be included as a separate device or included as part of the receiver block 310 or other processing blocks suitable adapted for such processes), and input to at least one finger of a rake receiver component, which herein comprises three fingers or paging channel demodulators: a first demodulator 312, a second demodulator 314, and a third demodulator 316. The outputs of the demodulators (312, 314, and 316) are combined for synthesization (or despreading of the spread spectrum signal) via a combiner 317, the output passed therefrom for subsequent processing according to conventional processes. Note that the rake receiver can include a lesser or greater number of demodulators in accordance with the particular application.

The digitized output of the receiver 310 is also fed to a search processor 318, having an associated searcher PN generator 320, both of which are utilized for initial synchronization and acquisition with one or more of the N base stations.

The device 302 also includes a short PN code generator 322 that receives sleep mode power from a short code generator power source 323, and a long PN code generator 324. The short code generator 322 connects to the search processor/code generator blocks (318 and 320), the long PN code generator 324, and demodulators (312, 314, and 316) and, is utilized for loading the other PN code generators (320 and 324) for facilitating despreading of the received CDMA signal at the demodulators (312, 314, and 316). The long PN code generator 324 is used to provide several randomizing functions in the IS-95 system. These include providing chips for message-scrambling privacy on the forward and reverse links, for identifying individual mobile devices and access channels on the reverse links by using unique offsets for each product entity, for randomizing the location of the power control bits on the forward traffic channels, and for randomizing the output on the reverse traffic channels.

The mobile device 302 also includes a system processor 326, which can be a high-speed digital signal processor. The system processor 326 connects to at least the short code generator 322, the long code generator 324, and search processor 318. Associated therewith is also a non-volatile memory 328 for storing instructions executable by the system processor 326. The memory 328 can also be used to store a LUT 330 comprising the generated reacquisition time data and associated active set window time data that eventually can be accessed by the system processor 326 in preparation for reacquisition of the paging channel after leaving the sleep mode.

A timer 332 is connected to the system processor 326 to provide a trigger mechanism in accordance with the reacquisition time data such that the system processor 326 of the mobile device 302 wakes up, settles the analog circuitry, resynchronizes, and reacquires the paging signal prior to the next arrival of the paging slot and/or paging indicator bit. The mobile device also includes a transmitter component 334 for transmitting data therefrom in furtherance of conventional transmission techniques.

In order to determine if a mobile communications device incorporating the present invention is operating properly, it can be monitored for current consumption, which indicates the start of the wakeup time. If the wakeup time, determined as the difference in time from when the device starts draining more current and the beginning of the paging slot frame, changes with the active set window size, then the device reacquisition time is dependent on the active set window size.

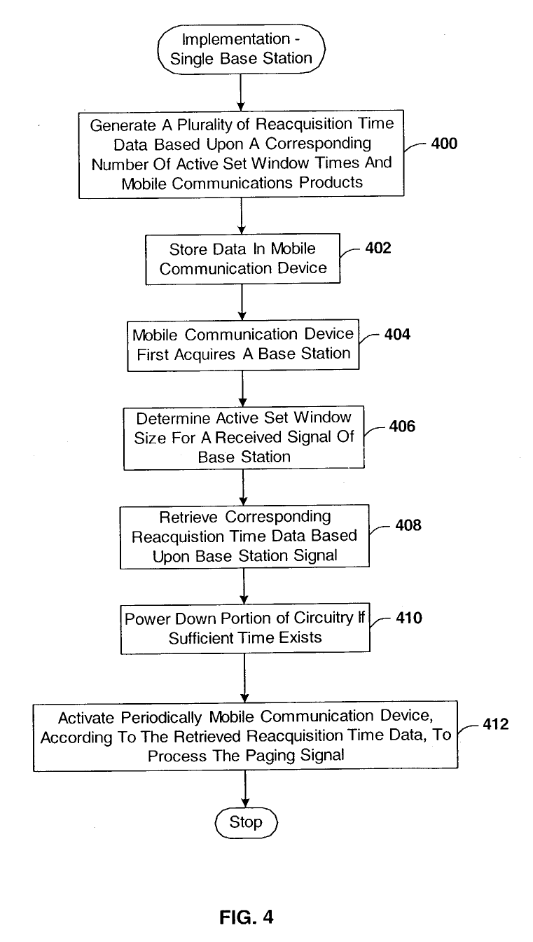

Referring now to FIG. 4, there is illustrated a flow chart of a methodology for implementation of the variable reacquisition time in a mobile communications device in accordance with the present invention. At 400, preparation begins by generating a plurality of reacquisition time data based upon a corresponding number of different active set window times and mobile communications device products. At 402, the data is then stored in the mobile communication device for later retrieval. Note that the processes of 400 and 402 occur only once, since the radiotelephone is sold with the look-up table already configured and installed in the non-volatile memory. This can be stored in a non-volatile memory, including but not limited to, flash memory and electronically erasable programmable read-only memory (EEPROM). Other non-volatile memory architecture can be suitably employed for storing the reacquisition time data in the mobile communications device.

At 404, when in operation, the mobile communications device first acquires a base station signal. The device then processes the signal to determine the active set window size of the transmitted signal of the base station, as indicated at 406. At 408, once the active set window size is determined, a look-up operation is performed with the stored memory data to retrieve the corresponding reacquisition time data. At 410, if no paging slot data (or indicator bits) is expected, or if paging data has been received after which a predetermined amount of time has passed, the device will enter sleep mode by deactivating a portion of its circuitry. At 412, the mobile communications device will then periodically activate its circuitry, according to the reacquisition time data, to monitor the page slot channel and/or the page bit indicator channel to determine if a paging message is forthcoming. The process then reaches a Stop block.

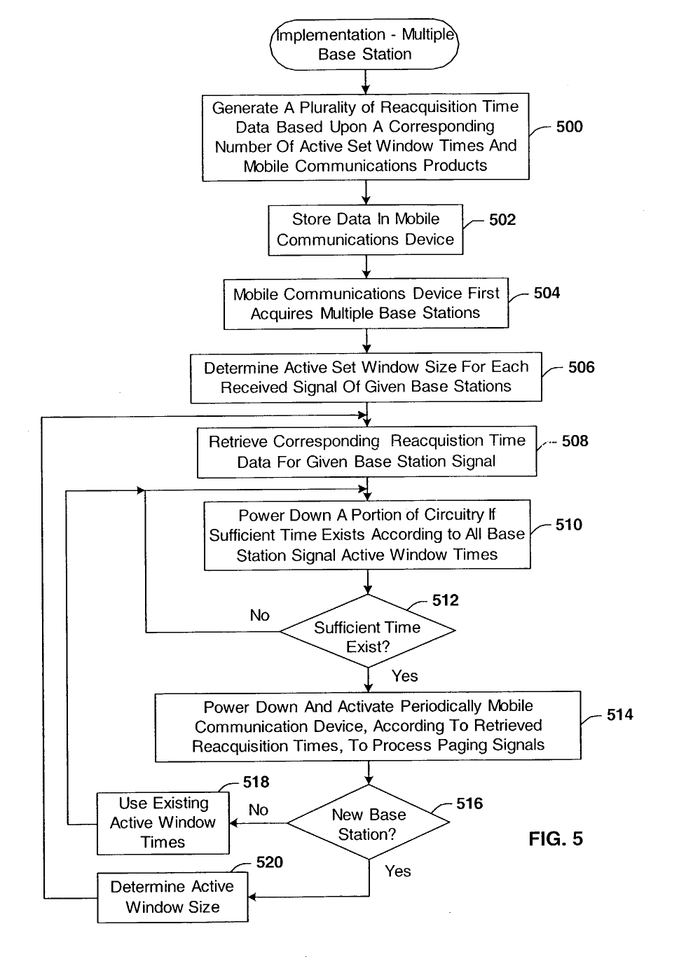

Referring now to FIG. 5, there is illustrated a flow chart of the process for addressing multiple signals from a plurality of base stations in a moving multipath scenario. At 500, preparation begins by generating a plurality of reacquisition time data based upon a corresponding number of different active set window times and mobile communications device products. At 502, the data is then stored in a table in memory of the mobile communication device for later retrieval. At 504, when in operation, the mobile communications device first acquires base station signals from the plurality of base stations. This can occur as the mobile communications device travels with the user through one or more communications cells that include the plurality of base stations. The base stations are strategically located to maintain signal channel integrity over the geographic area. Signal acquisition does not necessarily occur simultaneously, but can occur gradually as the user moves through various signal strengths associated with a geographic area and the plurality of base stations. Thus it is appreciated by one skilled in the art that the device can initially be communicating with a single first base station, but as the user moves away from the first base station, signal strength from other base stations increases such that there is a “soft” communications environment where the communications device actively communicates channel information over more than one base station channel. At 506, the device then processes the signal as the base station signals are acquired to determine the respective active set window size of the transmitted signal.

At 508, once the active set window size is determined, a look-up operation is performed with the stored memory data to retrieve the corresponding reacquisition times for each of the active station signals with which the device is communicating. At 510, if sufficient time exists, after considering all of the respective active set window times, portions of the communications device circuitry can be powered down. At 512, a determination is made as to whether sufficient time exists. If NO, flow loops back to the input of 510 to continue monitoring if sufficient time exists to power down. If YES, that is, if no paging slot data is expected or quick page indicator bits set, or if paging data has been received after which a predetermined amount of time has passed for all channels, the device will enter sleep mode by deactivating a portion of its circuitry, as indicated at 514. Note also, that in some implementations, the mobile communications device may activate periodically according to the shortest reacquisition time of the set. At 516, as the device moves geographically, it must be determined if a new base station signal needs to be acquired. If NO, the existing active window times are utilized, as indicated at 518, and flow is back to the input of 510 to power down if sufficient time exists. If YES, the new base station signal is acquired and the new active window size for the new base station is determined, as indicated at 520. Flow is then back to 508 where the associated reacquisition time is retrieved.

It is to be appreciated that the reacquisition time data and/or the LUT itself can be cached in a high-speed memory, which can be different than the non-volatile memory, such that the comparison process occurs more quickly so as to not degrade performance of the acquisition process.

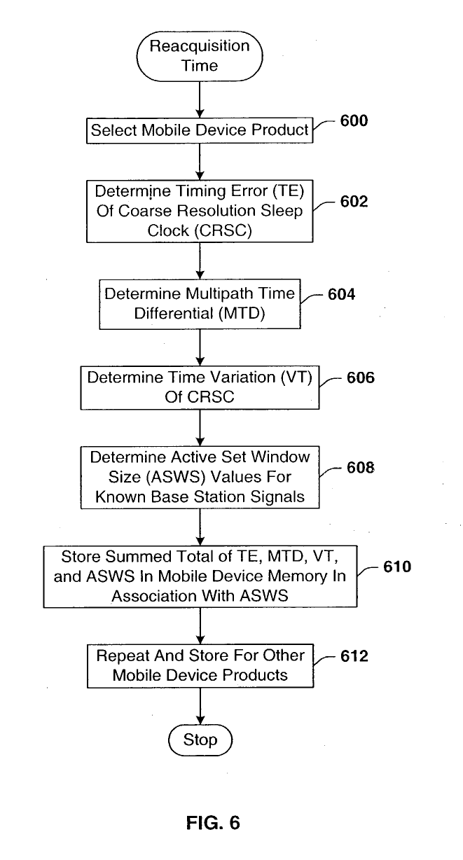

Referring now to FIG. 6, there is illustrated a flow chart of the methodology for determining the variable acquisition time at 400 of FIG. 4, in accordance with the present invention. The reacquisition time will vary depending upon at least four factors: the active window size of the base station signal; timing error of the coarse resolution sleep clock of the mobile device; multipath time differential as the device moves geographically; and time variation (or drift) of the mobile device coarse resolution clock when the mobile device is unsynchronized (or asleep) with the base station. Thus several factors depend on the hardware components of the type of mobile device utilized. For example, a first radiotelephone (or mobile communications device) design can incorporate electronic hardware (e.g., timing logic) that when operational causes to be generated a reacquisition time that is different from a reacquisition time of a second device design. That is, the first radiotelephone can operate from internal coarse resolution clock of 64 kHz, while a second radiotelephone may operate according to an internal coarse resolution clock speed of 32 kHz. Thus the times for these devices are incorporated into the look-up table such that the factor times can be quickly summed and/or extracted form the table by an internal algorithm to arrive at the appropriate device reacquisition time. In furtherance thereof, at 600, the determination process begins by selecting a mobile device product for which the reacquisition time is to be determined. At 602, the timing error (TE) associated with the coarse resolution sleep clock of the particular mobile device is determined. For example, where the timing error of the coarse resolution sleep clock is 32 kHz, timing cannot be resolved to better than approximately 1,228.8/32=38.4 chips (where one chip corresponds to approximately 0.8 microseconds, as prescribed in the IS-95 standard, the time it takes to transmit a bit or single symbol of a PN code). Thus a variation of ± one sleep clock relates to ±38.4 chips (yielding a rounded-up two-sided window size time of approximately seventy-seven chips).

At 604, the multipath time differential (MTD) that occurs during the sleep time of the mobile product is determined. This time is determined according to any possible multipath movement during the sleep time of the radiotelephone product. For example, if the radiotelephone was stationary during the sleep :mode, the multipath time differential would be zero, or a value that is relatively insignificant for calculating the reacquisition time in accordance with the present invention. However, if it is assumed that the radiotelephone travels at approximately 100 km/h (or approximately 63 mph) which is either generally in the direction of the base station or away from the base station, and a slot cycle of two is assumed (which relates to approximately five seconds of sleep time), the multipath time differential will not vary more than approximately ±½ chip. This yields a two-side multipath value of one.

At 606, variation in time (VT) of the coarse resolution sleep clock during sleep mode is determined. Continuing with the previous example of a 32 kHz sleep clock, if for example, the clock frequency drifted from 32.0000 kHz to 32.0001 kHz during the 5-second sleep time, the time variation is determined to be approximately (32.0001×5)−(32000.1×5)=0.5. Converting the time variation value to chips, results in 0.5×38.4=19.2 chips, giving a rounded-up two-sided window of approximately forty chips (actually 38.4 chips).

At 608, the active set window size (ASWS) is determined for the transmitting base station signal being searched by the mobile device. The window size of the active set may be typically twenty chips, yielding a two-sided window of forty chips. Other ASWS values include, but are not limited to, ten, thirty, forty chips, etc.

After waking up, the searcher has to be programmed with a window size sufficiently large to account for all the timing uncertainties. The sum of the four time values (TE, ASWS, MTD, and VT, in chips) is the reacquisition window size used by the searcher logic. In practice, this sum value may or may not be stored in a table. Alternatively, it could be calculated as a formula. For this specific example, the reacquisition window size=active window size+77+38.4+1=156.4 chips.

The reacquisition time, measured in seconds, partially depends on the reacquisition window size, since the time it takes for the search logic to find the multipaths depends on the search window. Other factors include, for example, the searcher's clock and analog circuits settling time. The data in the look-up table is used to calculate the sleep time. At 610, the four time values (TE, ASWS, MTD, and VT) are then summed to arrive at the reacquisition window size, and stored in the device memory in association with the active set window size value. At 612, the process is repeated for other mobile device products and active set window times, with the corresponding reacquisition times stored in the device memory in association with corresponding ASWS values for later accessing by the radiotelephone processor. As indicated hereinabove, the reacquisition time partially depends on the search window size determined by reading the overhead data of the transmitted base station signal during the first search after waking up.

Thus the overall reacquisition window size has to be sufficiently large to account for the above factors, which when summed according to the above example, yield an approximate reacquisition widow size of 156.4 chips. The process than reaches a Stop block.

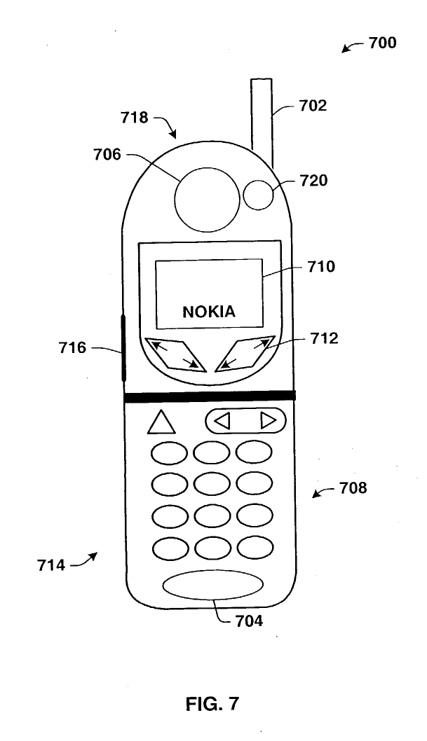

Referring now to FIG. 7, there is illustrated a portable telephone 700 incorporating the novel aspects of the present invention. The telephone includes an antenna 702 for communicating radio signals with one or more base stations. The telephone 700 further includes a microphone 104 into which audio signals are received and from which the onboard processor processes audio signals for transmission, and an audio speaker 706 for outputting audio signals to the user including but not limited to, processed voice signals of the caller and recipient, music, and alarms and notification tones or beeps. A keypad 708 is provided to allow at least user input for dialing telephone numbers, selecting options provided in the telephone 700, and to navigate a software menuing system provided onboard in accordance with telephones configuration features. In accordance with many conventional portable telephones, a display 710 is provided for displaying information to the user such as the inputted telephone number, caller telephone number (i.e., caller ID), and notification information. The display 710 can be a color or monochrome LCD (liquid crystal display) that requires low operational power.

Where the telephone is suitable for Internet communications, web page and electronic mail (e-mail) information can also be presented separately or in combination with the audio signals. In furtherance thereof, the telephone 700 includes user input display navigation buttons 712 that allow the user to interact with the display information. In support of such capabilities, the keypad 708 provides keys that facilitate alphanumeric input, and are multifunctional such that the user can respond by inputting alphanumeric and special characters via the keypad 708 in accordance with e-mail or other forms of messaging communications. The keypad keys also allow the user to control at least other telephone features such as audio volume and display brightness. Of course, positioning the corresponding keys in any suitable location of the telephone 700 can provide such functionality. Included within the telephone 700 is a power source 714 (not visible), e.g., a battery, which provides power to all onboard systems when the user is mobile.

The telephone 700 includes the internal memory (not visible) for storing the table of reacquisition values. The table memory can be located within the housing of the telephone 700 such that physical access by the user is precluded. Additionally, a second type of memory (not visible) can be provided and accessible by the user for storing greater amounts of data and information. For example, the second memory, which can be a conventional removable non-volatile flash memory card of various technologies, can be utilized to at least store web page information, e-mail content, and track the history of user interactions with the telephone 700. The user can access the second memory through a slot 716 in the housing. The telephone 700 can also include a high-speed data interface 718 (not visible) such as USB (Universal Serial Bus) and IEEE1394 for communicating data with a computer. Such interfaces can be used for uploading and downloading information to memory, for example, the reacquisition time data to the telephone table memory, and other information of the telephone second memory, e.g., website information and content, caller history information, address book and telephone numbers, and music residing in the second memory. Of course the table memory and the second memory can be a single non-removable memory device. A power button 720 allows the user to turn the telephone power on or off.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates power conservation in a mobile communications device, comprising:
an acquire component for acquiring a transmitted signal; and
a control component for determining reacquisition time data associated with the transmitted signal, and periodically activating the mobile communications device from a partially powered down state in accordance with the reacquisition time data.

2. The system of claim 1, the mobile communications device operating in a discontinuous reception regime of a Code Division Multiple Access (CDMA) communications environment.

3. The system of claim 1, the reacquisition time data based on an active window size of the transmitted signal.

4. The system of claim 1, the reacquisition time data varying according to the respective transmitted signal.

5. The system of claim 1, the reacquisition time data varying according to a reacquisition window size.

6. The system of claim 5, the reacquisition window size determined according to at least one of an active window data, resolution of a coarse sleep clock, frequency of the coarse sleep clock, and a multipath time differential.

7. The system of claim 1, the reacquisition time data varying according to a reacquisition window size

8. The system of claim 1, the mobile communications device further comprising a storage component for storing a predetermined plurality of different reacquisition time data.

9. The system of claim 1, the control component extracting active window data of the transmitted signal and determining the reacquisition time data associated with the active window data.

10. The system of claim 1, the reacquisition time data determined according to at least one of an active window data, resolution of a coarse sleep clock, frequency of the coarse sleep clock, and a multipath time differential.

11. The system of claim 1, the reacquisition time data determined as a sum of an active window data of the transmitted signal, timing error of a coarse resolution clock, drift time of the coarse resolution clock, and a multipath differential time.

12. The system of claim 1, the transmitted signal including at least one of paging channel and a quick paging channel wherein the control component periodically activates the mobile communications device in accordance with the reacquisition time data to process the paging channel or quick paging channel.

13. The system of claim 1, the reacquisition time data determined automatically in response to the control component determining active window data of the transmitted signal.

14. The system of claim 1, the reacquisition time data determined according to at least one of an active window data, resolution of a coarse sleep clock, frequency of the coarse sleep clock, and a multipath time differential, which resolution of the coarse sleep clock, frequency of the coarse sleep clock, and multipath time differential are determined according to the given mobile communications device.

15. Architecture that facilitates power conservation in a mobile communications device, the mobile communications device comprising:
an acquire component for acquiring a transmitted signal;
a storage component for storing predetermined reacquisition time data; and
a control component for determining active window data associated with the transmitted signal, the control component periodically activating the mobile communications device from a partially powered down state in accordance with the reacquisition time data associated with the active window data, and reacquiring the transmitted signal.

16. The architecture of claim 15, the active window data varying according to the transmitted signal, the transmitted signal one of a plurality of transmitted signals received by the mobile communications device.

17. The architecture of claim 15, the reacquisition time data determined according to at least one of the active window data, resolution of a coarse sleep clock, frequency of the coarse sleep clock, and a multipath time differential.

18. The architecture of claim 15, the reacquisition time data selected according timing parameters of the mobile communications device and the active window data.

19. The architecture of claim 15, the transmitted signal including at least one of a paging channel and a quick paging channel wherein the control component periodically activates the mobile communications device in accordance with the reacquisition time data to process the paging channel or quick paging channel.

20. Architecture that facilitates power conservation in a mobile communications device, the mobile communications device comprising:
an acquire component for acquiring a plurality of transmitted signals;
a storage component for storing a plurality of predetermined reacquisition time data; and
a control component for determining active window data associated with each of the acquired transmitted signals, the control component periodically activating the mobile communications device from a partially powered down state in accordance with corresponding reacquisition time data associated with the active window data of respective transmitted signals, and reacquiring the respective transmitted signals.

21. The architecture of claim 20, the active window data varying according to the respective transmitted signals.

22. The architecture of claim 20, the reacquisition time data determined according to at least one of the active window data, resolution of a coarse sleep clock, frequency of the coarse sleep clock, and a multipath time differential.

23. The architecture of claim 20, the reacquisition time data for the respective transmitted signals selected according timing parameters of the mobile communications device and the corresponding active window data.

24. The architecture of claim 20, the transmitted signal including at least one of a paging channel and a quick paging channel wherein the control component periodically activates the mobile communications device in accordance with the respective reacquisition time data of the corresponding transmitted signals to process the paging channel or quick paging channel.

25. A telephone according to the architecture of claim 20.

26. A method of conserving power in a mobile communications device operating in discontinuous reception mode, comprising:
determining a reacquisition time associated with a received signal, the reacquisition time based at least in part on active window data of the received signal; and
periodically activating a portion of the mobile communications device in accordance with the reacquisition time in order to process a paging signal portion of the received signal.

27. The method of claim 26, the reacquisition time determined according to at least one of the active window data, resolution of a coarse sleep clock, frequency of the coarse sleep clock, and multipath time differential during a sleep mode.

28. The method of claim 26, further comprising,
storing the reacquisition time in the mobile communications device; and
accessing the stored reacquisition time in response to processing the associated received signal.

29. The method of claim 28, the stored reacquisition time accessed in response to determining the active window data.

30. The method of claim 28, the reacquisition time stored in the form of a look-up table in the mobile communications device.

31. The method of claim 30, the look-up table including a plurality of reacquisition times stored in association with respective active set window times.

32. The method of claim 26, the reacquisition time determined as the sum of the active set window size of the base station, timing error of a coarse resolution clock, time variation of the coarse resolution clock during a period of non-activation, and a multipath differential time.

33. The method of claim 26, the paging signal including at least one of a paging slot channel and a paging indicator bit channel.

34. The method of claim 26, the mobile communications device operating in a CDMA communications regime.

35. An apparatus for conserving power in a mobile communications device operating in discontinuous reception mode, comprising:
means for determining a reacquisition time associated with a received CDMA signal, the reacquisition time based at least in part on an active window size of the received signal; and
means for periodically activating a portion of the mobile communication device in accordance with the reacquisition time in order to process a paging signal of the received signal.

36. A method of conserving power in a mobile communications CDMA device operating in discontinuous reception mode, comprising:
storing a plurality of reacquisition times in the mobile communications device, each of the reacquisition times stored in association with a time component;
acquiring one or more transmitted signals; and
periodically activating a portion of the mobile communications device in accordance with the time component of the acquired transmitted signal, the time component varying among the one or more transmitted signals acquired by the mobile communications device.

37. The method of claim 36, the reacquisition times determined according to at least one of an active window time of the acquired transmitted signal, resolution of a coarse sleep clock, frequency of the coarse sleep clock, and multipath time differential during a sleep mode.
